(19) United States
(12) Patent Application Publication
(10) Pub. No.: US 2014/0185155 A1
(43) Pub. Date: Jul. 3, 2014

(54) ELECTROMAGNETIC-WAVE TRANSMITTING COVER FOR VEHICLE

(71) Applicant: HYUNDAI MOTOR COMPANY, Seoul (KR)

(72) Inventors: Seung Mok Lee, Osan (KR); Bock Cheol Lee, Suwon (KR); Phil Jung Jeong, Yongin (KR); Hyun Gyung Kim, Hwaseong (KR); Young Sub Oh, Suwon (KR); Dong Eun Cha, Suwon (KR)

(73) Assignee: HYUNDAI MOTOR COMPANY, Seoul (KR)

(21) Appl. No.: 13/859,938

(22) Filed: Apr. 10, 2013

(30) Foreign Application Priority Data
Dec. 28, 2012 (KR) 10-2012-0156637

(51) Int. Cl. G02B 5/26

(52) U.S. Cl. CPC G02B 5/26
USPC 359/884

(57) ABSTRACT

Disclosed is an electromagnetic-wave transmitting cover for a vehicle, in which color paint is applied to or plastic color resin is coupled to a film member having good electromagnetic-wave transmittance characteristics, thus realizing a metallic appearance.

### CROSS-REFERENCE TO RELATED APPLICATION

This application claims under 35 U.S.C. §119(a) the benefit of Korean Patent Application No. 10-2012-0156637 filed Dec. 28, 2012 the entire contents of which are incorporated herein by reference.

### BACKGROUND OF THE INVENTION

1. Field of the Invention

The present invention relates to an electromagnetic-wave transmitting cover for a vehicle and, more particularly, to an electromagnetic-wave transmitting cover for a vehicle which provides good electromagnetic-wave transmittance and metallic luster properties through color matching between a film having good electromagnetic-wave transmittance characteristics and paint applied to the back of the film or resin coupled to the film.

2. Description of the Related Art

Various textures and effects, such as a wood grain effect, a mother-of-pearl effect or a metallic effect, are provided to decorative parts of a vehicle in order to improve aesthetic appearance. Recently, a metallic effect (metallic color) of high brightness is commonly required.

In order to secure electromagnetic-wave transmittance characteristics and a metallic effect, a conventional method involves depositing a metallic film, such as indium (In) or tin (Sn). However, the conventional method is problematic in that such metallic films increase costs, and even more problematically, increase environmental pollution due to toxicity.

FIG. 1 shows a method of manufacturing a conventional electromagnetic-wave transmitting cover for a vehicle. In particular, a transparent cover 11 is manufactured by injection molding with a plastic resin. In order to provide electromagnetic-wave transmittance characteristics and a metallic effect to an inner surface of the transparent cover 11, a metallic film 12, such as indium or tin, is deposited thereon. Thereafter, a plastic resin 13 is integrally coupled to the back of the transparent cover 11 by insert molding. In this way, an electromagnetic-wave transmitting cover 10 is obtained.

However, such a conventional electromagnetic-wave transmitting cover 10 is problematic in that the metallic film 12, which uses materials such as indium or tin, considerably increases manufacturing costs and causes environmental pollution.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention provides an electromagnetic-wave transmitting cover for a vehicle which imparts good electromagnetic-wave transmittance characteristics and metallic luster properties. In particular, desired electromagnetic-wave transmittance characteristics and metallic luster properties are provided through the use of a film having good electromagnetic-wave transmittance characteristics and having a color that matches a paint applied to the back of the film or resin coupled to the film. The present invention, thus, reduces manufacturing costs and, more importantly, prevents environmental pollution by eliminating the use of a metallic film, such as indium or tin, that are conventionally used.

According to one aspect, the present invention provides an electromagnetic-wave transmitting cover for a vehicle comprising: a film member made by repetitively stacking resin layers having different transmittance characteristics and refractive indices for transmitted visible rays; and a base layer located on a back of the film member and configured for reflecting visible rays that have passed through the film member, the base layer being provided with a metallic appearance by the reflected visible rays.

According to various embodiments, the electromagnetic-wave transmitting cover further includes a transparent cover coupled to a front of the film member. The transparent cover can be configured so as to protect the film member and provide the film member with a uniform thickness.

According to various embodiments, the base layer is translucent or is opaque in color, which can be provided by application of translucent or opaque color paint to a surface (i.e. back surface) of the film member.

According to various embodiments, he base layer is translucent or is opaque in color by coupling a translucent or opaque plastic color resin to a surface (i.e. back surface) of the film member.

According to various embodiments, the base layer includes one or more plastic resins coupled to a surface (i.e. back surface) of the film member, and further includes translucent or opaque color paint applied to a surface of the resin facing the film member.

According to various embodiments, translucent or opaque image forming paint may be further applied to a surface of the film member opposite the base layer so as to form a specific image.

According to various embodiments, the electromagnetic-wave transmitting cover may further include a base resin and a transparent cover coupled to surround the film member and the base layer. According to various embodiments, the base resin and transparent cover are provided so as to protect the film member and provide a uniform thickness.

As is apparent from the above description, the electromagnetic-wave transmitting cover for the vehicle according to the present invention is advantageous in that color paint is applied to or plastic color resin is coupled to a film member having good electromagnetic-wave transmittance characteristics. As such, a metallic appearance is provided, without the use of a metallic film such as indium or tin. As a result, manufacturing costs are reduced and environmental pollution due to such metallic films is eliminated.

Other aspects and exemplary embodiments of the invention are discussed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a conventional electromagnetic-wave transmitting cover for a vehicle; and

FIGS. 2 to FIGS. 8A and 8B are views illustrating an electromagnetic-wave transmitting cover for a vehicle according to embodiments of the present invention.

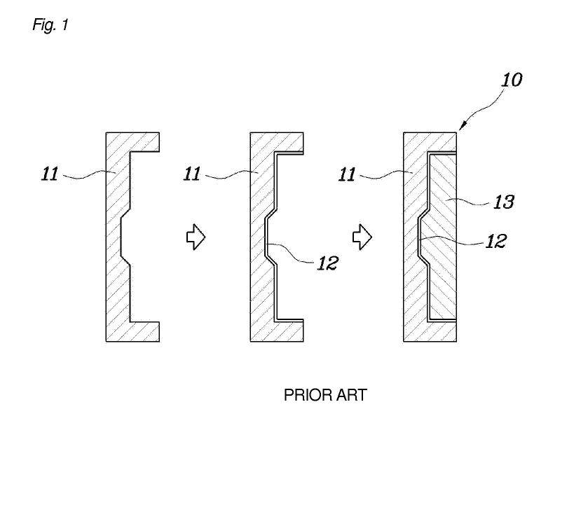

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

Hereinafter, an electromagnetic-wave transmitting cover for a vehicle according to a preferred embodiment of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 10, 0.5%, 0.1%, 0.05%, or 0.01% of the stated value. Unless otherwise clear from the context, all numerical values provided herein are modified by the term “about”.

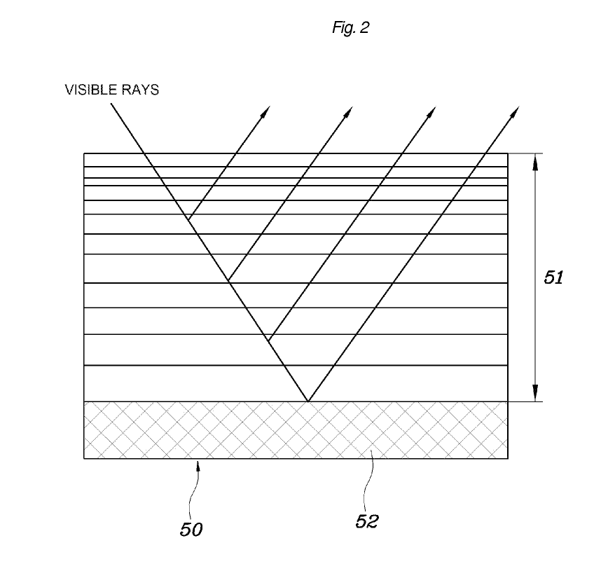

As shown in FIG. 2, the electromagnetic-wave transmitting cover 50 for a vehicle according to an embodiment of the present invention includes a film member 51 and a base layer 52. In particular, the film member 51 comprises a plurality of stacked resin layers, wherein at least some of the resin layers have different transmittance characteristics and refractive indices for transmitted visible rays. According to preferred embodiments, each of the resin layers is provided with different transmittance characteristics and refractive indices than all of the other resin layers. Further, the base layer 52, which is located on a back surface (or bottom surface as shown in FIG. 2) of the film member 51, is configured so as to reflect visible rays that have passed through the film member 51, and so as to provide a metallic appearance from the reflected visible rays.

According to embodiments of the invention, the resin layers forming the film member 51 are selected from high refractive polymers and low refractive polymers. Such polymers are not necessarily limited, and generally are those having high brightness, natural metallic properties, and, preferably, superior formability. Further, after the resins have been applied in a stack on the base layer and processed to their desired formed, they maintain their metallic properties without separation of the resin layers, and while providing superior electromagnetic-wave transmittance characteristics.

The general characteristics with respect to the film member 51 can be in accordance with that described in Korean Patent Laid-Open Publication No. 10-2008-0034889. Thus, a further description thereof will be omitted herein.

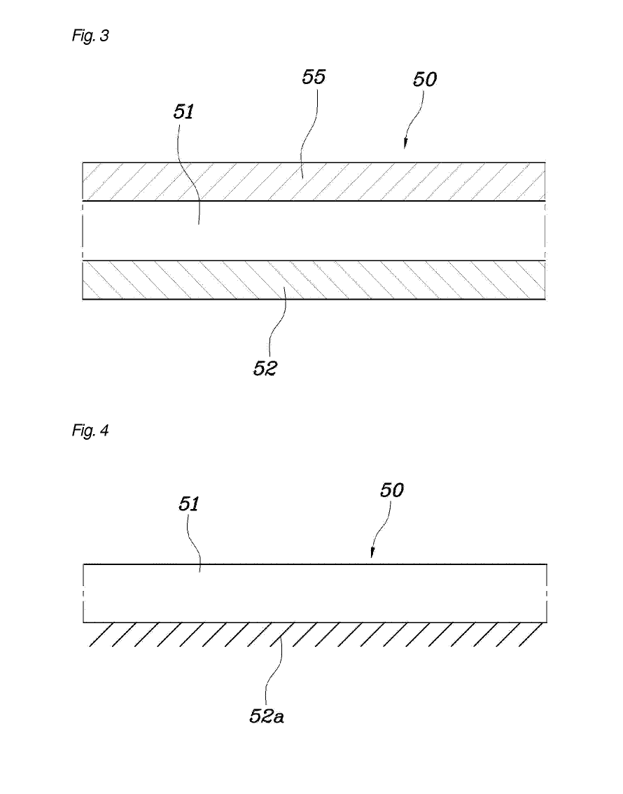

As shown in FIG. 3, the present invention further includes a transparent cover 55 that is coupled to a front surface (or top surface as shown in FIG. 3) of the film member 51. In particular, as shown, the film member 51 is provided sandwiched between the base layer 52 and the transparent cover 55. The transparent cover 55 can be provided so as to protect the film member 51 and to provide a uniform thickness thereto.

Meanwhile, as shown in FIG. 4, the base layer 52 according to an embodiment of the present invention can be in the form of translucent or opaque color paint 52a that is applied to a bottom surface of the film member 51.

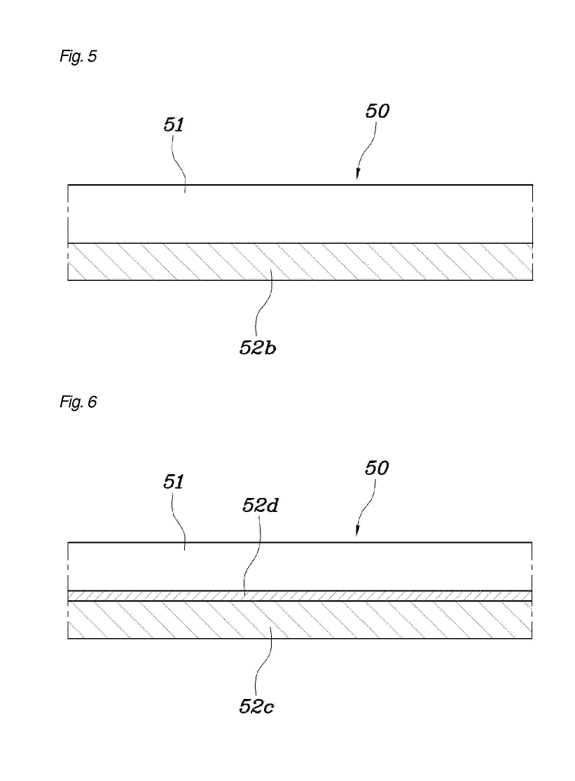

Further, as shown in FIG. 5, the base layer 52 according to another embodiment of the present invention can be a translucent or opaque plastic color resin 52b that is coupled to a bottom surface of the film member 51.

Furthermore, as shown in FIG. 6, the base layer 52 according to still another embodiment of the present invention can include a plastic resin 52c that is coupled to a bottom surface of the film member 51, with translucent or opaque color paint 52d is applied to a surface of the resin 52c facing the film member 51. In other words, a translucent or opaque color paint 52d can be sandwiched between the bottom surface of the film member 51 and the plastic resin 52c, as shown in FIG. 6.

According to various embodiments, the plastic resin 52c may be transparent resin. However, the plastic resin 52c is preferably a translucent or opaque resin so as to enhance the metallic appearance.

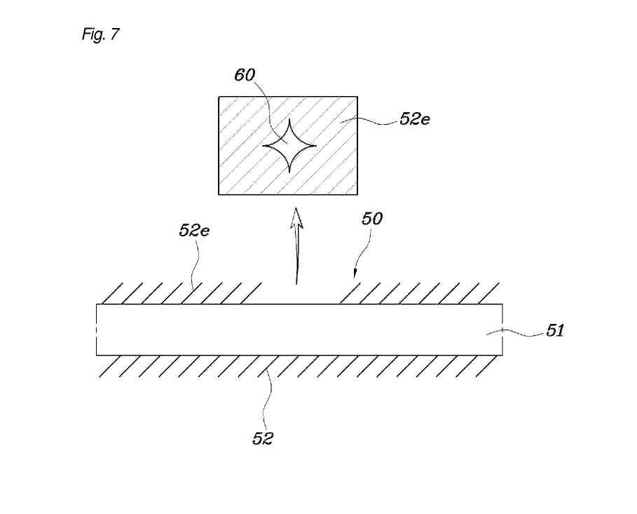

According to embodiments of the present invention as shown in FIG. 7, when the base layer 52 is positioned on a bottom surface of the film member 51 to realize a metallic appearance, a translucent or opaque image forming paint 52e can be further applied to an opposite (“upper”) surface of the film member 51 opposite the surface on which the base layer 52 is provided. The translucent or opaque image forming paint 52e can be provided so as to form an image 60 of a specific pattern on the upper surface of the film member 51.

In other words, the base layer 52 can be disposed on one surface of the film member 51 to achieve a metallic appearance, while the image forming paint 52e can be applied to an opposite surface to form a specific image 60. Thus, instead of providing a metallic effect, a specific image 60 can be provided.

According to various embodiments, the image 60 may be a symbol or logo.

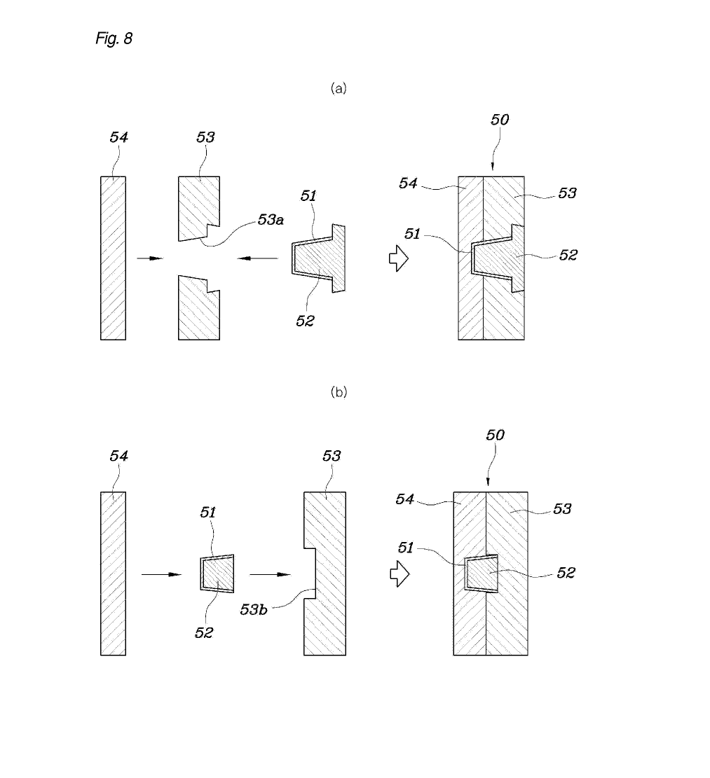

Further, as shown in FIGS. 8A and 8B, the present invention can further include a base resin 53 and a transparent cover 54 that are coupled to surround the film member 51 and the base layer 52, thus providing a electromagnetic-wave transmitting cover 50 with a uniform thickness.

Meanwhile, FIG. 8A shows a configuration wherein the base layer 52 is coupled with the film member 51 and is inserted in a direction such that an upper surface (right side as shown in FIR. 8B) of the base layer 52 is inserted towards a back surface (left side as shown in FIG. 8B) of the base resin 53. To this end, an assembly hole 53a is formed in the base resin 53 into which the base layer 52 can be inserted.

Further, FIG. 8B shows a configuration wherein the base layer 52 is coupled with the film member 51 and is then inserted into the back of the base resin 53. To this end, an assembly recess 53b is formed in the back of the base resin 53 as shown.

As such, if the thickness of the electromagnetic-wave transmitting cover 50 is kept uniform through use of the base resin 53 and the transparent cover 54, the reflecting performance of the visible rays is further improved, thereby providing improved metallic appearance.

As described above, the present invention provides an electromagnetic-wave transmitting cover 50 for a vehicle, in which color paint 52a is applied to or plastic color resin 52b is coupled to a film member 51 having good electromagnetic-wave transmittance characteristics. As a result, the present electromagnetic-wave transmitting cover 50 is provided with a metallic appearance.

Further according to the present invention, a metallic appearance is provided without the use of a conventional metallic film, such as indium or tin. This elimination of such metallic films significantly reduces manufacturing costs, and also, eliminates the environmental pollution associated with such films.

One example of an electromagnetic-wave transmitting cover for a vehicle is a smart cruise control sensor cover. Of course, it is possible to use various sensor covers other than the smart cruise control sensor cover.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electromagnetic-wave transmitting cover for a vehicle, comprising:
a film member comprising a plurality of stacked resin layers, each of the resin layers having different transmittance characteristics and refractive indices for transmitted visible rays; and
a base layer located on a back surface of the film member, the base layer configured and arranged to reflect visible rays that have passed through the film member, wherein the base layer is provided with a metallic appearance from the reflected visible rays.

2. The electromagnetic-wave transmitting cover as set forth in claim 1, further comprising:
a transparent cover coupled to a front surface of the film member, the transparent cover configured and arranged to protect the film member and provide the electromagnetic-wave transmitting cover with a uniform thickness.

3. The electromagnetic-wave transmitting cover as set forth in claim 1, wherein the base layer comprises translucent or opaque color paint applied to the back surface of the film member.

4. The electromagnetic-wave transmitting cover as set forth in claim 1, wherein the base layer comprises a translucent or opaque plastic color resin coupled to the back surface of the film member.

5. The electromagnetic-wave transmitting cover as set forth in claim 1, wherein the base layer comprises:
a plastic resin disposed at the back surface of the film member; and
a translucent or opaque color paint on a surface of the resin facing the film member, such that the translucent or opaque color paint is sandwiched between the back surface of the film member and the plastic resin.

6. The electromagnetic-wave transmitting cover as set forth in claim 1, wherein a translucent or opaque image forming paint is further applied to an front surface of the film member opposite the base layer so as to form a specific image.

7. The electromagnetic-wave transmitting cover as set forth in claim 1, further comprising:
a base resin and a transparent cover coupled to surround the film member and the base layer, the base resin and a transparent cover configured and arranged to protect the film member and provide the electromagnetic-wave transmitting cover with a uniform thickness.
